(19) United States
(12) Patent Application Publication
(10) Pub. No.: US 2026/0351797 A1
(43) Pub. Date: Nov. 5, 2026

(54) SEPARATOR FOR RECHARGEABLE BATTERY, ELECTRODE ASSEMBLY FOR RECHARGEABLE BATTERY AND RECHARGEABLE BATTERY INCLUDING THE SAME

(71) Applicant: SAMSUNG SDI CO., LTD., Yongin-si (KR)

(72) Inventor: Hui Jeong CHO, Suwon-si (KR)

(73) Assignee: SAMSUNG SDI CO., LTD., Yongin-si (KR)

(21) Appl. No.: 19/661,139

(22) Filed: Apr. 28, 2026

(30) Foreign Application Priority Data
May 2, 2025 (KR) 10-2025-0057964

(51) Int. Cl. H01M 50/457; H01M 50/414

(52) U.S. Cl. CPC H01M 50/457; H01M 50/414

(57) ABSTRACT

The present disclosure relates to a separator for a rechargeable battery and a rechargeable battery including the separator. The separator includes a porous substrate and a first layer formed on a first surface of the porous substrate, a second layer is formed on the first layer and includes a first region formed at a first end in a first direction of the porous substrate, and the first region is an antistatic region.

### CROSS-REFERENCE TO RELATED APPLICATION

The present application claims priority to and the benefit of Korean Patent Application No. 10-2025-0057964, filed on May 2, 2025 in the Korean Intellectual Property Office, the entire disclosure of which is incorporated herein by reference.

### BACKGROUND

### 1. Field of the Disclosure

The present disclosure relates to a separator for a rechargeable battery, an electrode assembly for a rechargeable battery, and a rechargeable battery including the separator.

### 2. Discussion of Related Art

With increasing presence of electronic devices such as, e.g., mobile phones, notebook computers, electric vehicles, and the like, that use batteries, the demand for secondary batteries having high energy density and high capacity is increasing. Therefore, improving the performance of rechargeable lithium batteries may be advantageous.

A rechargeable lithium battery includes a positive electrode and a negative electrode that contain an active material capable of the intercalation and deintercalation of lithium ions, and produces electric energy by oxidation and reduction reactions when the lithium ions are intercalated into and deintercalated from the positive electrode and the negative electrode.

### SUMMARY

The present disclosure is directed to a separator for a rechargeable battery that reduces mandrel extraction failure and improves air permeability.

The present disclosure is also directed to a separator for a rechargeable battery that reduces short circuits.

The present disclosure is also directed to an electrode assembly for a rechargeable battery including the above separator for a rechargeable battery, and a rechargeable battery. According to an aspect of the present disclosure, there is provided a separator for a rechargeable battery.

The separator for a rechargeable battery includes a porous substrate and a first layer formed on a first surface of the porous substrate, wherein a second layer is formed on the first layer and includes a first region formed at a first end in a first direction of the porous substrate, and the first region is an antistatic region.

According to another aspect of the present disclosure, there is provided an electrode assembly for a rechargeable battery.

The electrode assembly for a rechargeable battery includes an electrode and the above-described separator for a rechargeable battery.

According to still another aspect of the present disclosure, there is provided a rechargeable battery.

The rechargeable battery includes a positive electrode, a negative electrode, and the above-described separator for a rechargeable battery interposed between the positive electrode and the negative electrode.

### BRIEF DESCRIPTION OF THE DRAWINGS

The above and other objects, features and advantages of the present disclosure may become more apparent to those of ordinary skill in the art by describing example embodiments thereof in detail with reference to the accompanying drawings, in which:

FIG. 1 is a cross-sectional view of a separator for a rechargeable battery according to one example embodiment;

FIG. 2 is a plan view of a separator for a rechargeable battery according to one example embodiment;

FIG. 3 is a cross-sectional view of a separator for a rechargeable battery according to another example embodiment;

FIG. 4 is a cross-sectional view of a separator for a rechargeable battery according to still another example embodiment;

FIG. 5 is a plan view of a separator for a rechargeable battery according to another example embodiment;

FIG. 6 is a cross-sectional view of a separator for a rechargeable battery according to yet another example embodiment;

FIG. 7 is a top plan view of a separator for a rechargeable battery according to yet another example embodiment;

FIG. 8 is a bottom plan view of a separator for a rechargeable battery according to yet another example embodiment;

FIG. 9 is a conceptual view of an electrode assembly for a rechargeable battery according to one example embodiment;

FIG. 10 is a conceptual view of an electrode assembly for a rechargeable battery according to another example embodiment;

FIG. 11 to FIG. 14 are schematic cross-sectional views of a rechargeable battery according to one example embodiment; and

FIG. 15 illustrates short circuit generation during a process of manufacturing a stacked electrode assembly.

### DETAILED DESCRIPTION

Hereinafter, example embodiments of the present disclosure are described in detail. However, the embodiments are provided as examples, the present disclosure is not limited thereto, and the present disclosure is only defined by the scope of the claims to be described below.

Hereinafter, example embodiments of the present disclosure are described in detail with reference to the attached drawings. Terms or words used in this specification and claims should not be interpreted as limited to their typical or dictionary meanings, but should be interpreted with meanings and concepts that conform to the technical idea of the present disclosure. Therefore, it should be understood that the example embodiments described in this specification and the configurations illustrated in the drawings are only some of the example embodiments of the present disclosure and do not represent all of the technical idea of the present disclosure, and various equivalents and modifications may exist at the time of filing this application. In addition, when used in this specification, “comprise” and “include” and/or “comprising” specify the presence of mentioned shapes, numbers, steps, operations, elements, components and/or groups thereof, and do not exclude the presence or addition of one or more other shapes, numbers, operations, elements, components and/or groups. Additionally, when describing example embodiments of the present disclosure, the phrase “may be” may include “one or more example embodiments of the present disclosure.”

Furthermore, to aid understanding of the disclosure, the attached drawings may not be drawn to scale, but rather, the dimensions of some components may be exaggerated. Furthermore, the same reference numbers may be assigned to the same components in different embodiments.

Unless otherwise specified herein, when a part such as a layer, film, region, plate, and the like, is described as being “on” another part, it includes not only the case where the part is “directly on” the other part but also the case where there is still another part present therebetween.

Unless otherwise specified in this specification, anything indicated in the singular may also include the plural. Further, unless otherwise stated, “A or B” may mean “including A, including B, or including A and B.”

As used herein, the term “a combination thereof” may mean a mixture, laminate, composite, copolymer, alloy, blend, and reaction product of the components.

Herein, the term “particle diameter D100” refers to the average particle diameter, which means the diameter of particles with a cumulative volume of 100% by volume in the particle size distribution. The particle size distribution may be measured by methods well known to those skilled in the art. For example, the particle size distribution may be measured using, e.g., a particle size analyzer, a transmission electron micrograph, or a scanning electron micrograph. In another method, a D100 value may be obtained by measuring the particle diameter using a measuring device using dynamic light scattering, performing data analysis to count the number of particles for each particle size range, and then calculating the particle diameter therefrom. Alternatively, D100 may be measured using a laser diffraction method. For example, when measuring by laser diffraction, after the particles to be measured are dispersed in a dispersion medium, the particles may be introduced into a commercially available laser diffraction particle diameter measuring device (e.g., Microtrac MT 3000) and irradiated with ultrasonic waves of about 28 kHz at an output of 60 W, and the D100 based on 100% of the particle diameter distribution in the measurement device may be calculated.

In this specification, the term “particle diameter D50” refers to the average particle diameter of particles whose cumulative volume is 50% by volume in the particle size distribution. The “particle diameter D50” can be measured by referring to the method described in “particle diameter D100.”

In this specification, when a numerical range is described, “X to Y” means “X or more and Y or less (X≤ and ≤Y).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

According to one example embodiment, there is provided a separator for a rechargeable battery.

The separator for a rechargeable battery may be applied not only to rechargeable lithium batteries, but also to conventional rechargeable batteries other than rechargeable lithium batteries, such as, e.g., rechargeable sodium batteries.

The separator for a rechargeable battery may both reduce mandrel extraction failure and improve air permeability. The separator for a rechargeable battery may reduce short circuits.

The separator for a rechargeable battery includes a porous substrate and a first layer formed on a first surface of the porous substrate. On the first layer, a second layer, which includes a first region formed at a first end in a first direction of the porous substrate, is formed. The first region is an antistatic region.

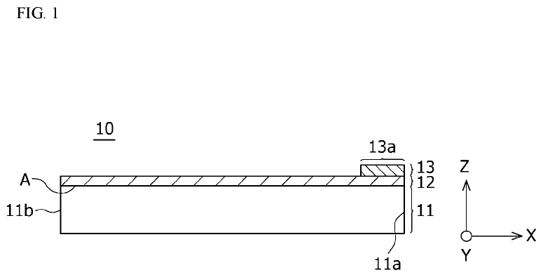

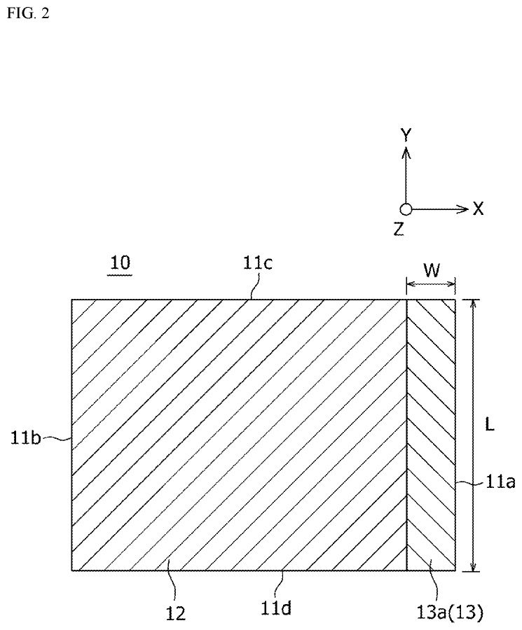

A separator for a rechargeable battery according to one example embodiment is described with reference to FIG. 1 and FIG. 2.

FIG. 1 is a cross-sectional view of a separator for a rechargeable battery according to one example embodiment. FIG. 2 is a plan view of a separator for a rechargeable battery according to one example embodiment.

A separator 10 for a rechargeable battery includes a porous substrate 11 and a first layer 12 formed on a first surface A of the porous substrate 11. A second layer 13 is formed on the first layer 12 and includes a first region 13a formed at a first end 11a in a first direction of the porous substrate 11. The first region 13a is an antistatic region.

In FIG. 1 and FIG. 2, the first direction of the porous substrate is shown as the X-axis, the second direction as the Y-axis, and the third direction as the Z-axis.

In an example, the first direction may be the machine direction of the porous substrate, the second direction may be the transverse direction of the porous substrate, and the third direction may be the thickness direction of the porous substrate. The first, second, and third directions may be orthogonal to each other.

The porous substrate 11 may have a machine direction and a transverse direction. In an example, the porous substrate may be or include a film manufactured by solution casting or melt extrusion of a composition including the polymer, or a copolymer or a mixture of two or more thereof. The machine direction may correspond to the casting direction during solution casting or the extrusion direction during melt extrusion. The transverse direction may be substantially perpendicular to the machine direction.

The porous substrate 11 includes a first end 11a and a second end 11b that is opposite to the first end 11a in the first direction.

The porous substrate 11 includes a first end 11c and a second end 11d that is opposite to the first end 11c in the second direction.

The porous substrate 11 has a plurality of pores and may be or include a substrate commonly used in electrochemical devices. The porous substrate may be or include a polymer film formed from any one polymer such as or including at least one of, but not limited to, polyolefins such as polyethylene and polypryopylene, polyesters such as polyethylene terephthalate and polybutylene terephthalate, polyacetal, polyamide, polyimide, polycarbonate, polyether ether ketone, polyaryletherketone, polyetherimide, polyamide-imide, polybenzimidazole, polyethersulfone, polyphenylene oxide, cyclic olefin copolymers, polyphenylene sulfide, polyethylene naphthalate, glass fiber, Teflon, and polytetrafluoroethylene, or a copolymer or a mixture of two or more thereof.

In one example, the porous substrate 11 may be or include a polyolefin-based film including a polyolefin. The polyolefin-based film may exhibit desired or improved shut-down functionality, which may enhance battery safety. For example, the polyolefin-based film may be or include at least one of a polyethylene single-layer film, a polypropylene single-layer film, a polyethylene/polypropylene double-layer film, a polypropylene/polyethylene/polypropylene triple-layer film, and a polyethylene/polypropylene/polyethylene triple-layer film. In addition, the polyolefin-based resin may include a non-olefin resin in addition to the olefin resin, or may include a copolymer of olefin and non-olefin monomers.

The porous substrate 11 may have a thickness in a range of about 1 μm to about 40 μm, for example, 1 μm to 30 μm, 1 μm to 20 μm, or 5 μm to 15 μm. Within this range, it may be used for a separator.

The second layer 13 is formed on the first layer 12. The second layer 13 includes the first region 13a.

The first region 13a is an antistatic region.

The antistatic region may reduce mandrel extraction failure when the separator is wound such that the first region 13a on the first surface 11a of the porous substrate 11 faces or comes into contact with the mandrel during winding. In an example, the separator may be wound on the mandrel in the machine direction of the porous substrate. In an example, the first region of the separator may come into contact with the mandrel during winding.

The first region 13a is formed at the first end 11a in the first direction of the porous substrate 11. While the first layer 12 is formed on the entire first surface A of the porous substrate 11, the first region 13a of the second layer 13 is formed only at the first end 11a in the first direction of the porous substrate 11. Accordingly, the separator may reduce mandrel extraction failure and reduce or minimize an increase in air permeability caused by the formation of the first region 13a.

In this disclosure, “mandrel extraction failure” may refer to a situation where after winding an electrode-separator laminate around a mandrel, the mandrel cannot be readily removed from the separator, or the mandrel and the separator are extracted together.

Herein, the electrode may be a positive electrode or a negative electrode.

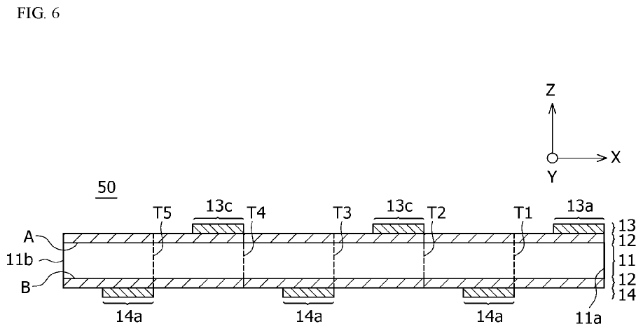

In an example, the first region 13a may be formed only at the first end 11a in the first direction of the porous substrate 11. However, when there is no increase in the air permeability of the separator, the first region 13a may additionally be formed on the first layer at any location other than the first end in the first direction of the porous substrate. This is described in detail with reference to FIG. 6 to FIG. 9.

The first region 13a may have a predetermined or desired width that extends from the first end 11c to the second end 11d in the second direction of the porous substrate 11. Accordingly, the separator may reduce mandrel extraction failure when the separator is wound on the mandrel in the machine direction of the porous substrate.

In an example, the width W of the first region 13a may be adjusted according to the diameter of the mandrel. For example, the width W of the first region 13a may be in a range of about 5 cm to about 20 cm. For example, the diameter of the mandrel may be in a range of about 1 cm to about 5 cm.

In an example, the length L of the first region 13a may be substantially the same as the length of the porous substrate 11 in the second direction.

The area of the first region 13a may be about 20% or less of the total area of the porous substrate 11, and may be, for example, in a range of about 0.1% to about 20%, or 0.1% to 5%. Within the above range, it is possible to effectively reduce mandrel extraction failure while reducing or minimizing an increase in the air permeability of the separator.

The area of the first region 13a may be about 20% or less of the total area of the first layer 12, and may be, for example, in a range of about 0.1% to about 20%, or 0.1% to 5%. Within the above range, it is possible to effectively reduce mandrel extraction failure while reducing or minimizing an increase in the air permeability of the separator.

The first region 13a may be or include an antistatic region, and may include an antistatic agent. The antistatic agent may include a conventional antistatic agent that has antistatic functionality.

In an example, the antistatic agent may be one capable of forming a first region with a surface resistivity of about 10¹⁰ Ω·m or less, for example, in a range of about 10¹ Ω·m to about 10¹⁰ Ω·m, 10⁵ Ω·m to 10¹⁰ Ω·m, or 108 Ω·m to 10⁹ Ω·m. Within the above range, the antistatic agent may be effective for reducing mandrel extraction failure.

In an example, the antistatic agent may be capable of forming a first region with an electrostatic charge of about −2 kV or more, for example, a range of about −2 kV to about 0 kV, or −1 kV to −0.1 kV. Within the above range, the antistatic agent may be effective for reducing mandrel extraction failure.

The surface resistivity and the electrostatic charge may be measured according to the methods described below.

In an example, the antistatic agent may be or include an inorganic material, an organic material, or a mixture thereof.

The inorganic material may include at least one of carbon nanotubes, graphene, metal oxides, and the like, but is not limited thereto.

In an example, the antistatic agent may be or include an organic material, for example a conductive polymer.

As is described below, the first layer 12 may include a filler to enhance the heat resistance of the separator. The first layer 12 containing the filler may have a predetermined or desired surface roughness. In addition, static electricity may be readily generated at the first layer 12 containing the filler due to friction. The conductive polymer, as an organic material, may be suitable for forming the first region on the first layer 12, wherein the first region has a surface roughness Ra and a dynamic coefficient of friction as described below. In an example, the conductive polymer may have a weight average molecular weight of about 100,000 g/mol or less, for example, a range of about 40,000 g/mol to about 90,000 g/mol, 60,000 to 90,000 g/mol, or 70,000 to 80,000 g/mol. Within this range, the polymer may exhibit a predetermined or desired viscosity, making it suitable for forming a thin first region with a surface roughness Ra and a dynamic coefficient of friction as described below.

The “weight average molecular weight” may be determined as a polystyrene-converted value using, e.g., gel permeation chromatography.

The conductive polymer may include conventional conductive polymers known to those skilled in the art. For example, the conductive polymer may include one or more of polyaniline (PANI), polypyrrole, polythiophene, polyselenophene, poly(3,4-ethylenedioxythiophene) (PEDOT), poly(3,4-ethylenedioxythiophene): polystyrenesulfonate (PEDOT:PSS), polyphenylene sulfide, and poly(p-phenylene vinylene). For example, the conductive polymer may be polyaniline (PANI). PANI may significantly enhance the effects of the present disclosure described above.

In an example, the antistatic agent may be included in the antistatic region in an amount of about 95 wt % or more, for example, in a range of about 95 wt % to about 100 wt %, or 100 wt %. Within the above range, the antistatic agent may be effective for reducing mandrel extraction failure through antistatic properties.

The surface roughness Ra of the first region 13a may be about 0.4 μm or less. Within the above range, the reduction in mandrel extraction failure may be further increased. For example, the surface roughness Ra of the first region may be greater than about 0 μm, and about 0.4 μm or less, in a range of about 0.01, 0.05, 00.1, 0.15, 0.2, 0.25, 0.3, 0.35, 0.4 μm, about 0.05 μm to about 0.4 μm, 0.1 μm to 0.4 μm, or 0.3 μm to 0.4 μm.

The surface roughness Ra of the first region may be measured by the method described below.

The dynamic coefficient of friction of the first region 13a may be about 0.3 or less. Within the above range, the occurrence of mandrel extraction failure may be further reduced. For example, the dynamic coefficient of friction of the first region may be greater than about 0 and 0.3 or less, in a range of about 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, about 0.05 to about 0.3, 0.1 to 0.3, or 0.2 to 0.3.

The dynamic coefficient of friction of the first region may be measured by the following method.

Measurement of friction coefficient:
Measurement instrument: Toyoseiki Friction Tester TR-2
Measurement conditions: Sled size (62×62 mm), Sled weight (200 g), Measurement speed (100 mm/min), Measurement distance (30 mm)
Sample size: Separator with MD 10 cm x TD 8 cm

Measurement procedure: The separator is fixed to the sled using tape so that the TD direction of the separator aligns with the movement direction of the friction coefficient measurement instrument. At the start of the first measurement, the zero button is pressed without any sample loaded to release any pre-existing tension in the instrument. The friction measurement plate is cleaned thoroughly with a wiper and fixed using tape. The sled is attached to the hook at the end of the instrument wire and positioned approximately 15 mm in front of the point where the wire is fully tensioned. After setting up the instrument according to the above measurement conditions, the start button is pressed, and the dynamic coefficient of friction is measured.

In an example, the surface roughness Ra and the dynamic coefficient of friction of the first region may be readily realized by using the above-described conductive polymer.

In an example, the surface roughness Ra and the dynamic coefficient of friction of the first region may be readily realized by using polyaniline, which is one of the above-described conductive polymers.

In an example, the surface roughness Ra and the dynamic coefficient of friction of the first region may be readily realized by using a conductive polymer with a weight average molecular weight within the above-described range.

In an example, the surface roughness Ra and the dynamic coefficient of friction of the first region may be readily realized by forming the first region on the first layer, which is described below, using the above-described conductive polymer.

The thickness of the second layer 13, for example, the thickness of the first region 13a, may be in a range of about 50% to about 150% (thickness ratio) of the thickness of the first layer 12. Within the above range, it is possible to reduce mandrel extraction failure, and the step difference between the first layer and the second layer may be reduced or minimized, resulting in reduced surface unevenness of the separator. For example, the thickness ratio may be in a range of about 50, 55, 60, 65, 70, 75, 80, 85, 90, 95, 100, 105, 110, 115, 120, 125, 130, 135, 140, 145, 150%, about 50% to about 130%, 70% to 120%, or 80% to 120%.

In an example, the thickness of the second layer 13, for example, the first region 13a, may be about 5 μm or less, for example, greater than about 0 μm and about 5 μm or less, in a range of about 0.01 μm to 3 about μm, 0.01 μm to 2 μm, or 0.5 μm to 2 μm. Within the above range, the second layer 13 may be used for a separator.

The first region 13a may be formed by a conventional method known to those skilled in the art using the above-described antistatic agent.

In an example, the first region may be formed by depositing or applying the antistatic agent. The first region may be or include a coating area or deposition area of the antistatic agent.

The first layer 12 is formed on the first surface A of the porous substrate 11.

In an example, the first layer may be formed on the entire first surface of the porous substrate. Accordingly, the first layer may enhance the heat resistance of the separator, thereby reducing thermal shrinkage. Alternatively, the first layer may have adhesive properties to enhance the adhesion between the separator and the electrode.

The surface roughness Ra of the first layer 12 may be greater than the surface roughness of the first region. Accordingly, the first layer may contribute to reducing or preventing an increase in the air permeability of the separator. The high surface roughness Ra of the first layer 12 may be achieved by the filler, and it is expected that increasing the spacing between the fillers may result in a decrease in the air permeability of the separator. However, the present disclosure is not limited thereto.

The dynamic coefficient of friction of the first layer 12 may be higher than the dynamic coefficient of friction of the first region. Accordingly, the first layer may contribute to reducing or suppressing an increase in the air permeability of the separator. The high dynamic coefficient of friction may be achieved by the filler, and it is expected that the filler may reduce the air permeability of the separator. However, the present disclosure is not limited thereto.

In an example, the surface roughness Ra of the first layer 12 may be about 0.5 μm or more. Within this range, an increase in the air permeability of the separator may be reduced or suppressed, and the target surface roughness Ra of the first region may be more readily achieved when forming the first region on the first layer. For example, the surface roughness Ra of the first layer may be in a range of 0.5, 0.6, 0.7, 0.8, 0.9, 1.0, 1.1, 1.2, 1.3, 1.4, 1.5, 1.6, 1.7, 1.8, 1.9, 2.0 μm, about 0.5 μm to about 2.0 μm, 0.5 μm to 1.5 μm, or 0.5 μm to 1.0 μm.

In an example, the dynamic coefficient of friction of the first layer 12 may be about 0.5 or more. Within this range, an increase in the air permeability of the separator may be reduced or suppressed, and the target dynamic coefficient of friction of the first region may be more readily achieved when forming the first region on the first layer. For example, the dynamic coefficient of friction of the first layer may be in a range of about 0.5, 0.6, 0.7, 0.8, 0.9, 1.0, about 0.5 to about 1.0, 0.5 to 0.9, 0.5 to 0.8, or 0.5 to 0.7.

The surface roughness Ra and the dynamic coefficient of friction of the first layer 12 may be measured by the respective methods described above.

The first layer 12 may include a filler (not shown in FIG. 1 and FIG. 2). The filler may adjust the surface roughness Ra of the first layer and enhance the heat resistance of the separator.

The filler may be or include an inorganic filler, an organic filler, an organic-inorganic composite filler, or a combination thereof. The inorganic filler may be or include a ceramic material capable of improving heat resistance. The inorganic filler may include at least one of metal oxides, metalloid oxides, metal fluorides, metal hydroxides, or combinations thereof. The inorganic filler may include, for example, at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or combinations thereof, but is not limited thereto. The organic filler may include at least one of acrylic compounds, imide compounds, amide compounds, or combinations thereof, but is not limited thereto. The organic filler may have a core-shell structure, but is not limited thereto. For example, the filler may be boehmite.

The filler may be spherical, plate-shaped, cubic, or amorphous.

The filler may have a particle diameter D100 of about 0.7 μm or less. Within this range, the air permeability of the separator may be controlled, and its heat resistance may be improved. For example, the filler may have a particle diameter D100 of about 0.55 μm or less, for example, in a range of about 0.3 μm to about 0.5 μm.

According to an example embodiment, the filler may have an average particle diameter D50 of about 0.4 μm or less, for example, about 0.35 μm or less, or in a range of about 0.1 μm to about 0.3 μm. Within the above range, the heat resistance of the separator may be improved.

The first layer 12 may further include a binder, in addition to the filler. The binder may allow the filler to be stably fixed in the first layer.

The binder may include one or more of a heat-resistant binder for enhancing the heat resistance of the separator, and an adhesive binder for enhancing the adhesion of the separator.

The heat-resistant binder may include a (meth)acrylic-based binder, but is not limited thereto.

The adhesive binder may include one or more of a core-shell type binder and a non-core-shell type binder. The adhesive binder may include one or more of a (meth)acrylic adhesive binder, such as polymethyl methacrylate (PMMA), and a fluorine-based adhesive binder, such as polyvinylidene fluoride or a polyvinylidene fluoride copolymer.

In an example, the first layer may include a heat-resistant binder and a filler.

In another example, the first layer may include a heat-resistant binder, a filler, and an adhesive binder.

In still another example, the first layer may include a layer containing a heat-resistant binder and a filler, and a layer containing an adhesive binder.

In an example, the first layer may be a single layer or a double layer.

The binder: the filler weight ratio may be in a range of about 1:10 to about 1:50, for example, 1:20 to 1:30. Within the above range, the first layer may be formed without increasing the air permeability of the separator.

The first layer 12 may be formed from a composition including the filler and the binder. The first layer 12 may have a thickness in a range of about 0.01 μm to about 20 μm, and may have a thickness of 1 μm to 10 μm, 1 μm to 5 μm, or 1 μm to 3 μm within the above range.

Hereinafter, a separator according to another example embodiment is described.

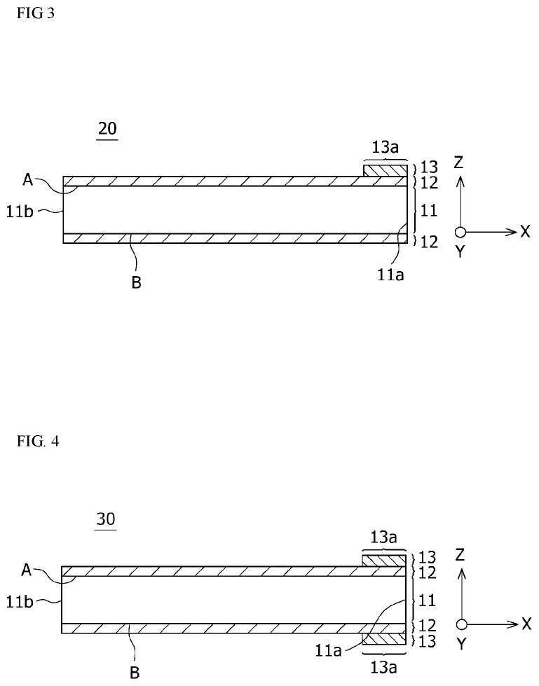

FIG. 3 is a cross-sectional view of a separator for a rechargeable battery according to another example embodiment.

A separator 20 for a rechargeable battery includes a porous substrate 11 and a first layer 12 formed on a first surface A of the porous substrate 11. A second layer 13 is formed on the first layer 12 and includes a first region 13a formed at a first end 11a in a first direction of the porous substrate 11. The first region 13a is an antistatic region.

A first layer 12 may additionally be formed on a second surface B of the porous substrate 11. The first layer 12 may be formed on the entire second surface B of the porous substrate. The first layer 12 may be substantially the same as the first layer described above. The heat resistance of the separator 20 may be further improved by further including the first layer on the second surface B.

FIG. 4 is a cross-sectional view of a separator for a rechargeable battery according to still another example embodiment.

A separator 30 for a rechargeable battery includes a porous substrate 11 and a first layer 12 formed on a first surface A of the porous substrate 11. A second layer 13 is formed on the first layer 12 and includes a first region 13a formed at a first end 11a in a first direction of the porous substrate 11. The first region 13a is an antistatic region.

A first layer 12 may additionally be formed on a second surface B of the porous substrate 11, and a second layer 13 including the first region 13a formed at the first end 11a in the first direction of the porous substrate 11 may additionally be formed on the first layer 12. Since the second layer 13 is formed on both sides of the porous substrate 11, the separator 30 may be wound in either direction, thereby improving the usability of the separator 30.

Hereinafter, a separator according to still another example embodiment is described.

The first region may include a plurality of second regions spaced apart from each other from a first end to a second end in a second direction of the porous substrate 11. Each of the second regions is an antistatic region including the above-described antistatic agent. Accordingly, mandrel extraction failure of the separator may be reduced. In addition, since the second regions are spaced apart, the spaces between the second regions may be occupied by the first layer. As a result, the air permeability of the separator may be further reduced.

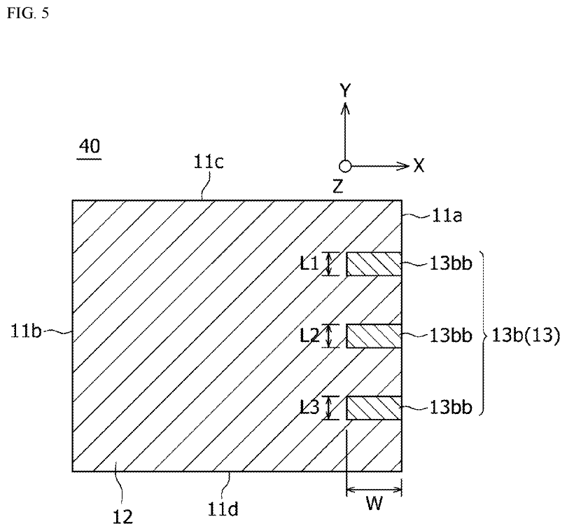

FIG. 5 is a plan view of a separator for a rechargeable battery according to still another example embodiment.

A separator 40 for a rechargeable battery includes a porous substrate 11 and a first layer 12 formed on a first surface of the porous substrate 11. A second layer 13 is formed on the first layer 12 and includes a first region 13b formed at a first end 11a in a first direction of the porous substrate 11.

The first region 13b is an antistatic region. The first region 13b may include a plurality of second regions 13bb that are spaced apart from each other from a first end 11c to a second end 11d in a second direction of the porous substrate 11. Each of the second regions 13bb may be or include an antistatic region including the above-described antistatic agent. The antistatic region may be substantially the same as described above.

Although FIG. 5 illustrates a separator with three second regions 13bb, the present disclosure is not limited thereto. Two or more second regions 13bb may be formed as part of the first region 13b.

The width W of each second region 13bb may be adjusted according to the diameter of the mandrel. For example, the width W of each second region 13bb may be in a range of about 5 cm to about 20 cm. For example, the diameter of the mandrel may be in a range of about 1 cm to about 5 cm.

The lengths L1, L2, and L3 of the respective second regions 13bb may be in a range of about 10% to about 20% of the length of the porous substrate 11 in the second direction. Within this range, a reduction in mandrel extraction failure and improvement in air permeability may be achieved.

Hereinafter, a separator according to yet another example embodiment is described.

The second layer may further include a plurality of third regions formed from the first end 11a to the second end 11b in the first direction of the porous substrate 11. The third regions may be spaced apart from each other.

The third region may include a plurality of second regions spaced apart from each other from the first end to the second end in the second direction of the porous substrate.

The separator may further include a third layer formed on a second surface of the porous substrate. The second surface may be opposite to the first surface. The third layer may include a plurality of fourth regions spaced apart from each other from the first end 11a to the second end 11b in the first direction of the porous substrate 11.

The fourth region may include a plurality of second regions spaced apart from each other from the first end to the second end in the second direction of the porous substrate.

The second region may be or include an antistatic region.

The third regions and the fourth regions may be alternately formed.

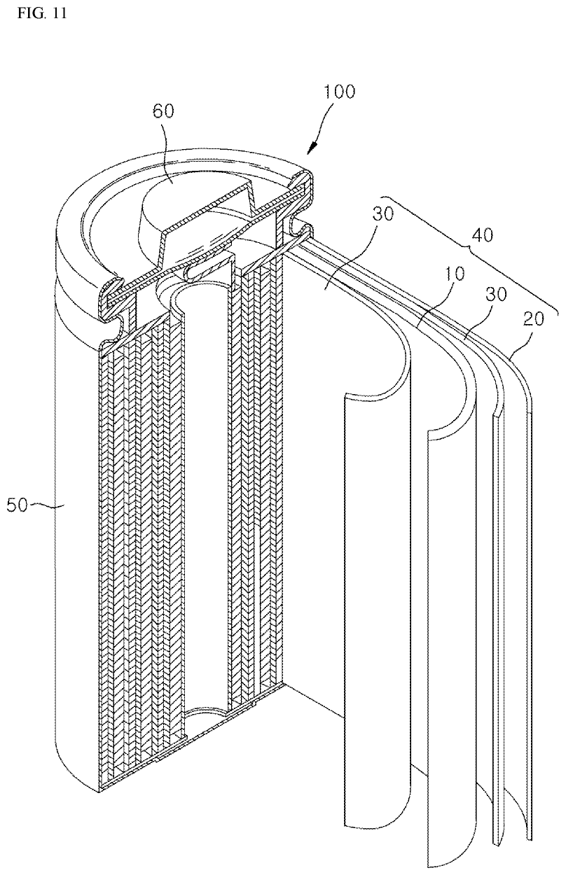

The separator may further reduce or prevent short circuits in the stacked electrode assembly described in FIG. 10 and FIG. 15. This is described in detail below with reference to FIG. 10 and FIG. 15.

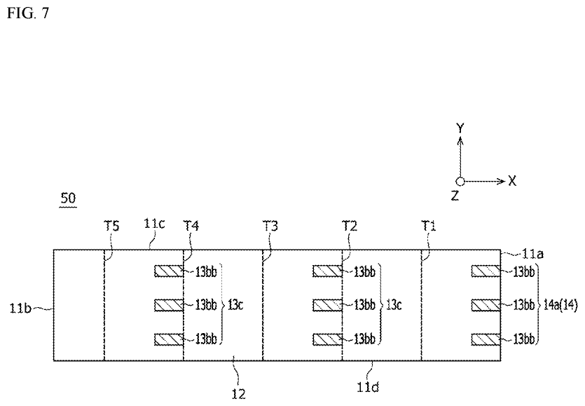

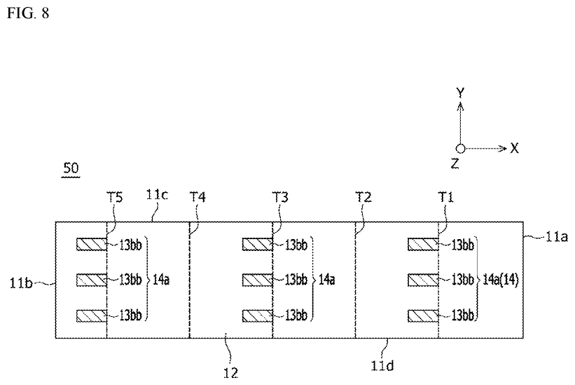

FIG. 6 is a cross-sectional view of a separator for a rechargeable battery according to yet another example embodiment. FIG. 7 is a top plan view of the separator for a rechargeable battery. FIG. 8 is a bottom plan view of the separator for a rechargeable battery.

A separator 50 for a rechargeable battery includes a porous substrate 11 and a first layer 12 formed on a first surface A of the porous substrate 11. The first layer 12 is the same as described above.

A second layer 13 is formed on the first layer 12. The second layer 13 may include a first region 13a and a third region 13c. The separator is substantially the same as described above, except that the second layer 13 further includes the third region 13c.

The separator 50 includes the first layer 12 formed on the second surface B of the porous substrate 11, and a third layer 14 is additionally formed on the first layer 12. The first layer 12 is the same as described above. The separator is substantially the same as described above, except that the third layer 14 is additionally formed.

Accordingly, the description below focuses on the third region 13c and the third layer 14.

A plurality of third regions 13c are formed from the first end 11a to the second end 11b in the first direction of the porous substrate 11. The third regions 13c may be spaced apart from each other.

The spacing between the third regions 13c may be adjusted according to the folding portions T1, T2, T3, and T4 of the separator. The folding portions T1, T2, T3, and T4 of the separator may be portions where the separator is folded in a stacked battery.

The third region 13c may include a plurality of second regions 13bb spaced apart from each other from the first end 11c to the second end 11d in the second direction of the porous substrate 11. The second region 13bb may be the above-described antistatic region.

Thus, the third regions 13c may reduce or prevent the generation of static electricity even when an external object intentionally comes into contact with them. This not only protects the separator from being damaged, but also helps to reduce or prevent short circuits.

In an example, the external object may be or include a clamp used in the process of manufacturing a stacked battery. This is described in detail below with reference to FIG. 15.

The second regions 13bb included in the third regions 13c may be substantially the same as the above-described second regions 13bb.

The thickness of the third region 13c may be within substantially the same range as the thickness of the second layer 13.

FIG. 6 to FIG. 8 illustrate a case where two third regions are formed. However, the number of third regions included in the second layer may be adjusted according to the number of folding portions of the separator in a stacked battery.

The third layer 14 may include a plurality of fourth regions 14a spaced apart from each other from a first end 11a to a second end 11b in the first direction of the porous substrate 11.

The fourth region 14a may include a plurality of second regions 13bb spaced apart from each other from a first end 11c to a second end 11d in the second direction of the porous substrate 11. The second region 13bb may be the above-described antistatic region.

Thus, the fourth regions 14a may reduce or prevent the generation of static electricity even when an external object intentionally comes into contact with them. This not only protects the separator from being damaged, but also helps to reduce or prevent short circuits. In an example, the external object may be or include a clamp used in the process of manufacturing a stacked battery. This is described in detail below with reference to FIG. 10 and FIG. 15.

The second regions 13bb included in the fourth regions 14a may be substantially the same as the second regions 13bb described above.

The fourth region 14a may not be in contact with the first end 11a in the first direction of the porous substrate 11. Instead, the fourth region 14a may be formed apart from the first region 13a of the second layer 12 along the first direction.

The third regions 13c in the second layer 12 and the fourth regions 14a in the third layer 14 may be alternately formed. In other words, the fourth region 14a of the third layer may be formed at the folding portion T1, the third region 13c of the second layer may be formed at the folding portion T2, the fourth region 14a of the third layer may be formed at the folding portion T3, and the third region 13c of the second layer may be formed at the folding portion T4

This arrangement may reduce or prevent static electricity from being generated at all folding portions T1, T2, T3, and T4 when the separator is folded in a serpentine shape, or zigzag shape along these folding portions T1, T2, T3, and T4.

The thickness of the fourth region 14a may be within substantially the same range as the thickness of the second layer 13.

FIG. 6 to FIG. 8 illustrate a case where three fourth regions 14a are formed. However, the number of fourth regions included in the third layer 14 may be adjusted according to the number of folding portions of the separator in a stacked battery. In addition, FIG. 6 to FIG. 8 show the third layer 14 formed on the first layer 12. However, the third layer 14 may be formed directly on the porous substrate 11.

Hereinafter, an electrode assembly for a rechargeable battery according to one example embodiment is described.

The electrode assembly according to one example embodiment may include an electrode and the separator for a rechargeable battery described above.

Herein, the electrode may be either a positive electrode or a negative electrode. The positive electrode and the negative electrode may be described in detail below.

The electrode assembly may be a jelly roll-type electrode assembly or a stacked electrode assembly.

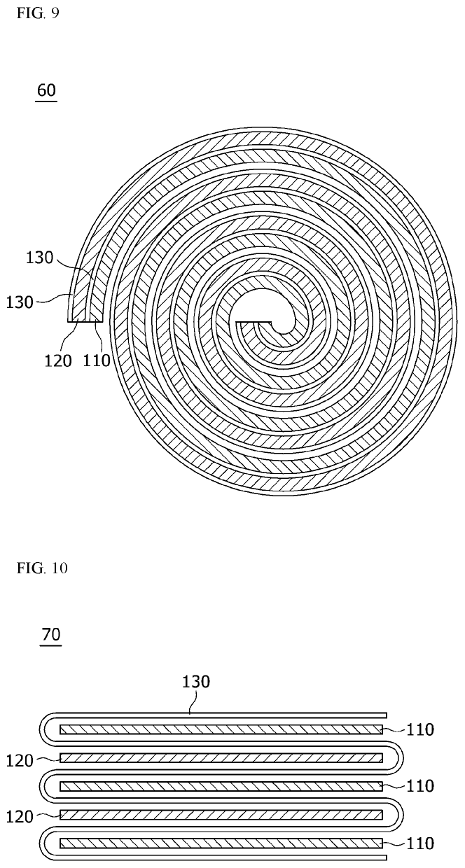

FIG. 9 is a cross-sectional view of an electrode assembly according to one example embodiment.

An electrode assembly 60 may have a jelly roll-type structure in which a laminate in which a positive electrode 110, a separator 130, and a negative electrode 120 are sequentially stacked is wound around a first region (not shown) of the separator 130.

FIG. 10 is a conceptual diagram of an electrode assembly according to another example embodiment.

An electrode assembly 70 may include a separator 130 that is folded multiple times in a serpentine shape, or zigzag shape, with alternating folds on both sides, a positive electrode 110 having a first tab member and inserted into the folds on one side of the separator 130, and a negative electrode 120 having a second tab member and inserted into the folds on the other side of the separator 130.

The electrode assembly 70 may reduce static electricity generation, thereby decreasing the risk of short circuits, by including the separator 130. This is described with reference to FIG. 15.

FIG. 15 illustrates part of the process of manufacturing a stacked electrode assembly according to one example embodiment.

A separator 1 may be folded multiple times in a serpentine shape, or zigzag shape, having first and second folded portions 2 and 3 alternately formed on one side and the other side, respectively. Although not shown in FIG. 15, each of the first and second folded portions 2 and 3 may be further provided with a fixing member to maintain the folded shape. The first and second folded portions 2 and 3 are regions into which a positive electrode 110 and a negative electrode 120 are inserted, respectively.

To reduce or prevent misalignment during winding, the separator 1 is temporarily fixed with a clamp 4, and then the positive electrode 110 and the negative electrode 120 are inserted. During this process, contact with the clamp 4 may generate static electricity, causing damage to the separator 1 at the point of contact. This damaged portion may cause short circuits.

In contrast, the electrode assembly 70 illustrated in FIG. 10 includes an antistatic region at a location corresponding to the contact area of the clamp, thereby reducing or preventing short circuits.

### Rechargeable Lithium Battery

According to one example embodiment, the rechargeable lithium battery includes the separator for a rechargeable lithium battery, a positive electrode, and a negative electrode.

The separator for rechargeable lithium battery refers to the description described above. The separator for rechargeable lithium battery may be positioned between the positive electrode and the negative electrode.

### Positive Electrode

A positive electrode for a rechargeable lithium battery may include a current collector and a positive electrode active material layer on the current collector. The positive electrode active material layer may include a positive electrode active material and may further include a binder and/or a conductive material. For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}CO_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, a high nickel-based positive electrode active material having a nickel content greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

An amount of the positive electrode active material may be in a range of about 90 wt % to about 99.5 wt % based on 100 wt % of the positive electrode active material layer. Amounts of each of the binder and the conductive material may independently be in a range of about 0.5 wt % to about 5 wt %, respectively, based on 100 wt % of the positive electrode active material layer.

The binder attaches the positive electrode active material particles to each other, and attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause chemical change (e.g., does not cause an undesirable chemical change in the rechargeable lithium battery) and that conducts electrons can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in a form of a metal powder or a metal fiber; a conductive polymer such as a polyphenylene derivative; or a mixture thereof.

Al may be used as the current collector, but the current collector is not limited thereto.

### Negative Electrode

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include a range of about 90 wt % to about 99 wt % of the negative electrode active material, a range of about 0.5 wt % to about 5 wt % of the binder, and a range of about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and may also attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in the form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone, or in combination of two or more solvents.

In addition, when using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane lithium tetrafluoroethanesulfonate, lithium sulfonate, difluorobis(oxalato)phosphate (LiDFOB), and lithium bis(oxalato) borate (LiBOB).

The rechargeable lithium battery may be classified into cylindrical, prismatic, pouch, or coin-type batteries, and the like depending on their shape.

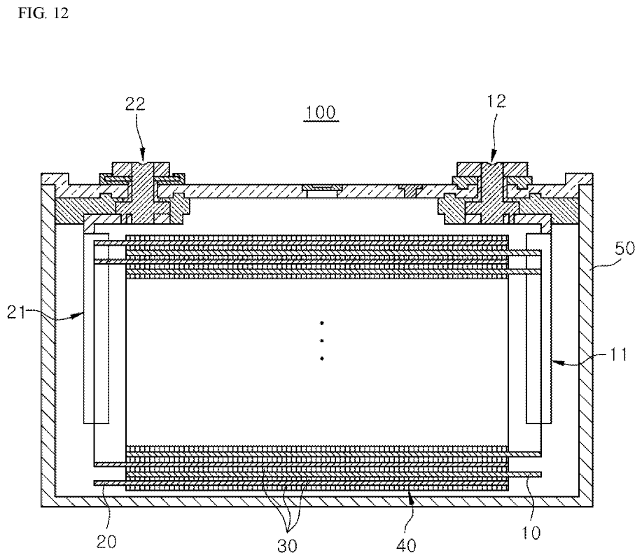

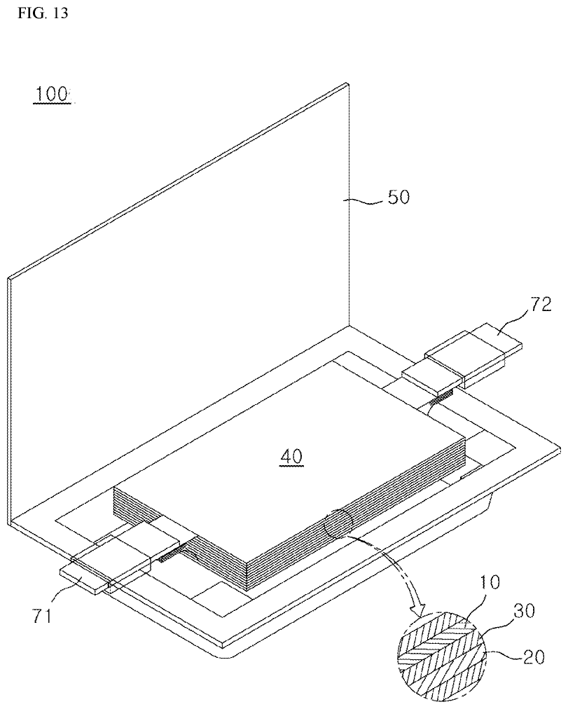

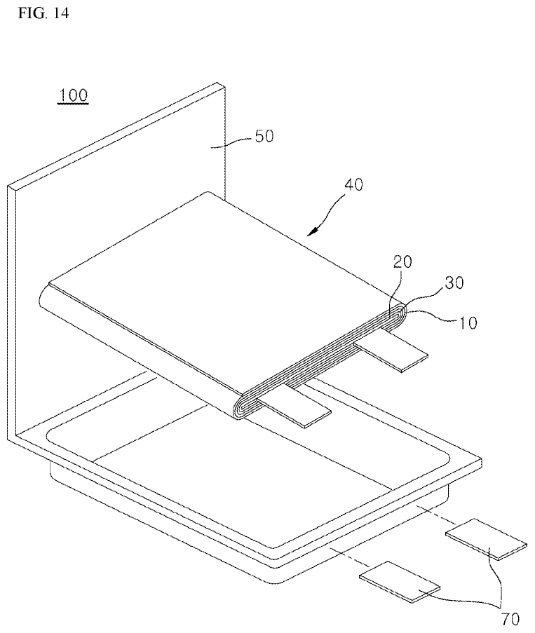

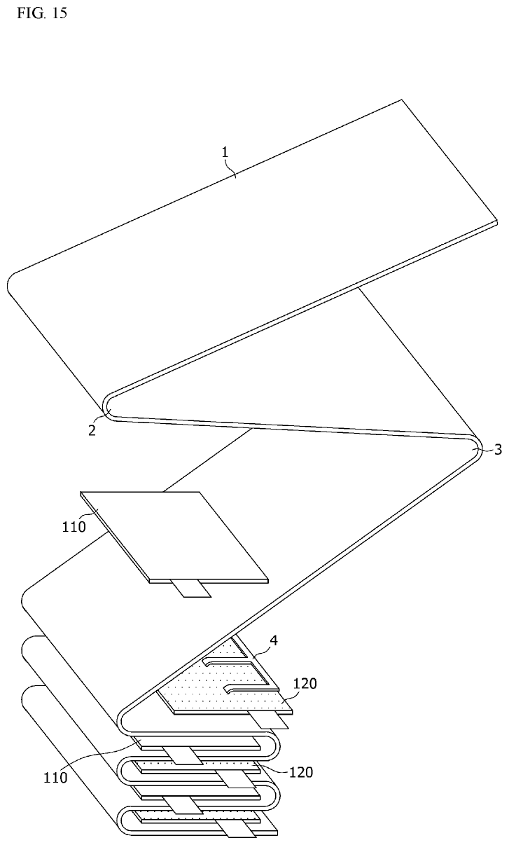

FIG. 11 to FIG. 14 are schematic views illustrating a rechargeable lithium battery according to an example embodiment. FIG. 11 shows a cylindrical battery, FIG. 12 shows a prismatic battery, and FIG. 13 and FIG. 14 show pouch-type batteries. Referring to FIG. 11 to FIG. 14, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 11. In FIG. 12, the rechargeable lithium battery 100 may include a positive lead tab 11, a positive terminal 12 connected to the positive lead tab 11, a negative lead tab 21, and a negative terminal 22 connected to the negative lead tab 21. As shown in FIG. 13 and FIG. 14, the rechargeable lithium battery 100 may include an electrode tab 70 illustrated in FIG. 14, or for example, a positive electrode tab 71 and a negative electrode tab 72 illustrated in FIG. 13, the electrode tabs 70/71/72 forming an electric path for inducing the current formed in the electrode assembly 40 to the outside of the battery 100.

The rechargeable lithium battery according to an example embodiment may be applicable to, e.g., automobiles, mobile phones, and/or various types of electric devices, as non-limiting examples.

Hereinafter, the examples and comparative examples of the present disclosure are described. However, the following examples are only illustrative examples of the present disclosure, and the present disclosure is not limited to the following examples.

### Example 1

A composition for a first layer was applied by die coating onto the entire first and second surfaces of a polyethylene-based porous substrate film (thickness: 10 μm, manufacturer: SK, air permeability: 150 sec/100 cc), and then dried to form respective first layers (thickness: 1.0 μm).

The composition for a first layer was prepared by mixing a methacrylic binder and boehmite (particle diameter D100: 0.5 μm) as a filler at a mass ratio of 1:20 based on solid content, adding the mixture to an aqueous solvent, and milling and dispersing it at 25 °C for 30 minutes using a bead mill.

A polyaniline (weight average molecular weight: 1,000,000 g/mol) solution was prepared as a conductive polymer, and was applied only onto the first end of the first layer in the machine direction of the polyethylene-based film and dried to form a second layer (thickness: 1.0 μm), thereby manufacturing a separator with the cross-sectional structure shown in FIG. 1.

### Example 2

A separator was manufactured in the same manner as in Example 1, except that the conductive polymer was changed as shown in Table 1.

### Example 3

A separator was manufactured in the same manner as in Example 1, except that the conductive polymer was changed as shown in Table 1.

### Comparative Example 1

A separator was manufactured in the same manner as in Example 1, except that the second layer was not formed in Example 1.

### Comparative Example 2

A separator was manufactured in the same manner as in Example 1, except that the polyaniline solution was applied onto the entire surface of the first layer and dried to form an antistatic region across the entire first layer.

The physical properties of the separators manufactured in the examples and comparative examples were evaluated as described below.

### Air Permeability (Units: See/100 cc)

The air permeability of the manufactured separator was measured using a measurement device (EG01-55-1MR, Asahi Seiko Co., Ltd.) by measuring the time (units: see) it takes for 100 cc of air to pass through the separator.

### Settings for Air Permeability Measurement Device:

Measurement pressure: 0.5 kg/cm², Cylinder pressure: 2.5 kg/cm², Setting time: 10 seconds

### Surface Roughness Ra (Units: μm)

The surface of the separator was measured using a microscope from Olympus. The arithmetic average roughness (Ra) value was obtained by calculating the arithmetic mean of the absolute vertical coordinates within the sampling length. The Ra values of both the first and second coating layers of the separator were calculated, and their average value was recorded.

### Dynamic Coefficient of Friction

Measurement instrument: Toyoseiki Friction Tester TR-2
Measurement conditions: Sled size (62×62 mm), Sled weight (200 g), Measurement speed (100 mm/min), Measurement distance (30 mm)
Sample size: Separator with MD 10 cm×TD 8 cm
Measurement procedure: The separator was fixed to the sled using tape so that the TD direction of the separator aligned with the movement direction of the friction coefficient measurement instrument. At the start of the first measurement, the zero button was pressed without any sample loaded to release any pre-existing tension in the instrument. The friction measurement plate was cleaned thoroughly with a wiper and fixed using tape. The sled was attached to the hook at the end of the instrument wire and positioned approximately 15 mm in front of the point where the wire is fully tensioned. After setting up the instrument according to the measurement conditions, the start button was pressed, and the dynamic coefficient of friction was measured.

### Static Electricity (Units: kV)

The electrostatic charge of the separator used in the lithium battery was measured, and the results are shown in Table 1 below. An electrostatic measurement instrument (775PVS) from Ion System was used for the measurement.

### Surface Resistivity (Units: Ω·m)

The measurement probe was placed and fixed on the electrode of the surface resistance meter, and the surface resistivity was measured after inputting the thickness and bulk resistivity of the current collector. A surface resistance meter was used for the measurement.

### Mandrel Extraction Failure

### Manufacture of Negative Electrode:

A negative electrode active material slurry was prepared by mixing 97 wt % of graphite particles with an average particle diameter D50 of 25 μm as a negative electrode active material, 1.5 wt % of a styrene-butadiene rubber binder, and 1.5 wt % of carboxymethyl cellulose (CMC), adding the mixture to distilled water, and stirring for 60 minutes using a mechanical stirrer. The slurry was applied onto a 10 μm thick copper foil using a doctor blade, dried in a hot air dryer at 100 °C for 0.5 hours, then further dried under vacuum at 120 °C for 4 hours, and finally roll-pressed to manufacture a negative electrode.

### Manufacture of Positive Electrode:

A positive electrode active material slurry was prepared by mixing 97 wt % of lithium cobalt oxide as a positive electrode active material, 1.5 wt % of carbon black powder as a conductive material, and 1.5 wt % of polyvinylidene fluoride, adding the mixture to an N-methyl-2-pyrrolidone solvent, and then stirring for 30 minutes using a mechanical stirrer. After applying the slurry onto a 20 μm thick aluminum current collector using a doctor blade, it was dried in a hot air dryer at 100 °C for 0.5 hours, followed by additional drying under vacuum at 120 °C for 4 hours, and then roll-pressed to manufacture a positive electrode.

### Jelly Roll-Type Electrode Assembly:

The positive electrode, separator, and negative electrode manufactured above were sequentially stacked, and the electrode assembly was wound into a jelly roll structure by bringing the first region of the separator into contact with a mandrel (diameter: 3.5Φ). The manufactured jelly roll electrode assembly was inserted into a cylindrical case, and then the mandrel was withdrawn from the electrode assembly. If the mandrel could not be readily removed from the separator, or if the mandrel and the separator were extracted together, it was evaluated as NG. If the mandrel could be readily removed from the separator without extracting the separator at the same time, it was evaluated as OK.

TABLE 1

| | | | | | Dynamic | | | |
|---|---|---|---|---|---|---|---|---|
| | Conductive | | | | coefficient | | | Mandrel |
| | polymer | | Air | | of | Static | Surface | extraction |
| | Type | Coating | permeability | Ra | friction | electricity | resistivity | failure |
| Example 1 | Polyaniline | Partial | 140 | 0.31 | 0.20 | −0.2 | 10⁹ | OK |
| | | area | | | | | | (0%) |
| Example 2 | Polypyrrole | Partial | 139 | 0.32 | 0.21 | −0.2 | 10⁹ | OK |
| | | area | | | | | | (0%) |
| Example 3 | PED | Partial | 140 | 0.32 | 0.22 | −0.2 | 10⁹ | OK |
| | OT | area | | | | | | (0%) |
| Comparative | — | — | 130 | 0.80 | 0.67 | −3.9 | 10¹⁵ | NG |
| Example 1 | | | | | | | | (30%) |
| Comparative | Polyaniline | Entire | 9865 | 0.37 | 0.21 | −0.2 | 10⁸ | OK |
| Example 2 | | surface | | | | | | (0%) |

* Mandrel extraction failure (%): failure rate

As shown in Table 1, the separators according to the examples both reduced mandrel extraction failure and improved air permeability.

According to one example embodiment, a separator for a rechargeable battery that both reduces mandrel extraction failure and improves air permeability is provided.

Another example embodiment provides a separator for a rechargeable battery that reduces short circuits.

Although the example embodiments of the present disclosure have been described above, the present disclosure is not limited thereto, various modifications are possible within the scope of the claims, detailed description, and attached drawings of the disclosure, and such modifications also fall within the scope of the present disclosure.

What is claimed is:

1. A separator for a rechargeable battery, the separator comprising:
a porous substrate; and
a first layer formed on a first surface of the porous substrate,
wherein a second layer is formed on the first layer and includes a first region formed at a first end in a first direction of the porous substrate, and the first region is an antistatic region.

2. The separator of claim 1, wherein the first region has a surface roughness Ra of about 0.4 μm or less, and a dynamic coefficient of friction of about 0.3 or less.

3. The separator of claim 1, wherein the first region is formed only at the first end in the first direction of the porous substrate.

4. The separator of claim 1, wherein the first region has a desired width that extends from a first end to a second end in a second direction of the porous substrate, and the second direction is orthogonal to the first direction.

5. The separator of claim 1, wherein the first layer has a greater surface roughness Ra and a greater dynamic coefficient of friction than the first region.

6. The separator of claim 5, wherein the first layer has a surface roughness Ra of about 0.5 μm or more and a dynamic coefficient of friction of about 0.5 or more.

7. The separator of claim 1, wherein the antistatic region comprises an antistatic agent, and the antistatic agent is a conductive polymer.

8. The separator of claim 7, wherein the conductive polymer comprises one or more of polyaniline (PANI), polypyrrole, polythiophene, polyselenophene, poly(3,4-ethylenedioxythiophene) (PEDOT), poly(3,4-ethylenedioxythiophene): polystyrenesulfonate (PEDOT:PSS), polyphenylene sulfide, and poly(p-phenylenevinylene).

9. The separator of claim 7, wherein the conductive polymer has a weight average molecular weight of about 100,000 g/mol or less.

10. The separator of claim 1, wherein the thickness of the second layer is in a range of about 50% to about 150% of the thickness of the first layer.

11. The separator of claim 1, wherein the first region comprises a plurality of second regions spaced apart from each other from a first end to a second end in a second direction of the porous substrate, and the second direction is orthogonal to the first direction.

12. The separator of claim 11, wherein each of the second regions comprises an antistatic region.

13. The separator of claim 11, wherein the second layer further comprises a plurality of third regions formed from the first end to a second end in the first direction of the porous substrate, and the third regions are spaced apart from each other.

14. The separator of claim 13, wherein each of the third regions includes a plurality of second regions spaced apart from each other from the first end to the second end in the second direction of the porous substrate.

15. The separator of claim 14, further comprising a third layer formed on a second surface of the porous substrate,
wherein the second surface is opposite to the first surface, and
the third layer includes a plurality of fourth regions spaced apart from each other from the first end to the second end in the first direction of the porous substrate.

16. The separator of claim 15, wherein each of the fourth regions includes a plurality of second regions spaced apart from each other from the first end to the second end in the second direction of the porous substrate.

17. The separator of claim 16, wherein the second regions in the third regions and the second regions in the fourth regions each comprise an antistatic region.

18. The separator of claim 17, wherein the third regions and the fourth regions are alternately formed along the first direction.

19. The separator of claim 15, wherein a first layer is further formed between the porous substrate and the third layer.

20. A rechargeable battery comprising:
a positive electrode;
a negative electrode; and
the separator for a rechargeable battery according to claim 1 interposed between the positive electrode and the negative electrode.
